(19) United States
(12) Patent Application Publication
(10) Pub. No.: US 2026/0319727 A1
(43) Pub. Date: Oct. 15, 2026

(54) DIGITAL PHOTO COLLAGE FRAME AND MOBILE APPLICATION DEVICE

(71) Applicant: Jace Green, Snowflake, AZ (US)

(72) Inventor: Jace Green, Snowflake, AZ (US)

(21) Appl. No.: 19/644,535

(22) Filed: Apr. 10, 2026

Related U.S. Application Data
(60) Provisional application No. 63/786,524, filed on Apr. 10, 2025.

(51) Int. Cl. G06F 3/14; G06F 3/04845; G06F 3/0486

(52) U.S. Cl. CPC G06F 3/1446; G06F 3/04845; G06F 3/0486

(57) ABSTRACT

A digital photo collage frame device is disclosed, which is a streaming photo system that makes it easy to create a wall-mounted digital scrapbook picture collage. The digital photo collage frame device comprises a screen component designed to display multiple images and that interacts with a mobile application on a smart device. The screen component is Bluetooth-enabled and compatible with any smart device which allows users to sync images and videos directly from their device through the related, easy-to-use mobile application. The mobile application allows users to customize the collage layout, assign specific images or videos to different screens, and set photos to rotate automatically. The device is designed as a single screen which is broken up into sections or as multiple screens which snap together or apart so a user may arrange, add, remove, etc., based upon their preference.

### CROSS REFERENCE TO RELATED APPLICATION

The present application claims priority to, and the benefit of, U.S. Provisional Application No. 63/786,524, which was filed on Apr. 10, 2025, and is incorporated herein by reference in its entirety.

### FIELD OF THE INVENTION

The present invention relates generally to the field of digital photo collage frame devices. More specifically, the present invention relates to an improved digital photo collage frame to display multiple photos without the need to link multiple frames. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in digital photo collage frame devices. Generally, many individuals enjoy displaying photos in a digital frame. However, linking digital frames can be challenging and difficult. Digital picture frames are a great way to display your photos, but it can be technically challenging and expensive to combine multiple frames into a single display.

Accordingly, there is a demand for an improved digital photo collage frame device that makes it easy to show multiple digital photos at once in a compact and stylish wall-mounted display. More particularly, there is a demand for a digital photo collage frame device that wirelessly syncs with a linked mobile application, so it's easy to choose the photos and videos to display, place them in specific positions, and rotate pictures to create the perfect display.

Therefore, there exists a long felt need in the art for a digital photo collage frame device that allows a user to create a wall-mounted digital scrapbook picture collage. There is also a long felt need in the art for a digital photo collage frame device that makes it easy to show multiple digital photos at once in a compact and stylish wall-mounted display. Further, there is a long felt need in the art for a digital photo collage frame device that can wirelessly sync with a linked mobile application so it's easy to choose the photos and videos to display, place them in specific positions, and rotate pictures to create the perfect display. Moreover, there is a long felt need in the art for a device that stores data so photos can display even without the linked smart phone. Further, there is a long felt need in the art for a digital photo collage frame device that can include optional customizable screen titles. Finally, there is a long felt need in the art for a digital photo collage frame device that allows each frame to display a still photo or multiple pictures in rotation.

The subject matter disclosed and claimed herein, in one embodiment thereof, comprises a digital photo collage frame device. The device is a streaming photo system that makes it easy to create a wall-mounted digital scrapbook picture collage. The digital photo collage frame device comprises a screen component designed to display multiple images and that interacts with a mobile application on a smart device. In one embodiment, the screen component comprises a series of interconnected screens in a customizable arrangement. The screens are manufactured in multiple sizes with various size screens, such as small, medium, and large, and may vary in portrait and landscape style. The screens are Bluetooth-enabled and compatible with any smart device which allows users to sync images and videos directly from their device through the related, easy-to-use mobile application. The mobile application allows users to customize the collage layout, assign specific images or videos to different screens, and set photos to rotate automatically. The device offers users a convenient and interactive way to display memories, creating a personalized experience for users. The device is designed as a single screen which is broken up into sections or as multiple screens which snap together or apart so a user may arrange, add, remove, etc., based upon their preference. Further the device can be customized in various ways including adding to the device with an expansion kit.

In this manner, the digital photo collage frame device of the present invention accomplishes all of the forgoing objectives and provides users with a means for displaying multiple images and videos on a screen component. The device syncs to a phone via Bluetooth. The device can be customized in various ways.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a digital photo collage frame device. The device is a streaming photo system that makes it easy to create a wall-mounted digital scrapbook picture collage. The digital photo collage frame device comprises a screen component designed to display multiple images and that interacts with a mobile application on a smart device. The screens are Bluetooth-enabled and compatible with any smart device which allows users to sync images and videos directly from their device through the related, easy-to-use mobile application. The device offers users a convenient and interactive way to display memories, creating a personalized experience for users.

In one embodiment, the digital photo collage frame device displays multiple photos without the need to link multiple frames. The device is a wireless digital photo frame that allows users to display multiple photos and videos in a customized arrangement and which can be set to rotate automatically through a plurality of previously selected photos and videos. The digital photo collage frame device wirelessly syncs with linked smart devices via Bluetooth and interacts with an easy-to-use mobile application on the smart devices.

In one embodiment, the digital photo collage frame device comprises a screen component for displaying digital photos and videos. The screen component can be any suitable shape and size as is known in the art for displaying multiple photos and videos. In one embodiment, the screen component is a single screen in a rectangular shape which is broken up into multiple sections. The multiple sections are different framed areas of the singular screen. The screen component disclosing a single screen can be of varying sizes depending on the needs and/or wants of a user. In another embodiment, the screen component comprises multiple screens which snap together or apart so a user may arrange, add, remove, etc., based upon their preference, thus allowing users to interconnect the multiple screens in a customizable arrangement. The multiple screens can be of varying sizes depending on the needs and/or wants of a user.

In one embodiment, the single screen with multiple sections and the multiple screens connected together can be manufactured in multiple sizes with various size screens, such as small, medium, and large, and may vary in portrait and landscape style, as well. Typically, the screen component is sized to the most common smart device ratio (19:9). For example, two large screens, four medium screens, six small screens, or other suitable ratio of screen sizes. Typically, the small, medium, and large screens are equally divided between landscape and portrait orientations. In one embodiment, the overall measurements of the screen component include approximately 40 inches wide by approximately 30 inches high but can be any suitable size as is known in the art.

In one embodiment, each screen or section of a single screen can display a still photo or multiple pictures in rotation or displays up to one minute of video loop playback. A user can assign specific images or videos to different screens or different sections of a single screen, and set photos to rotate automatically, thus allowing users to customize the collage device layout. Thus, the device offers users a convenient and interactive way to display memories, creating a personalized experience for users.

In one embodiment, the screen component comprises components, such as a microprocessor and transceiver which is compliant and compatible with existing smart device (cellular and mobile telephone phone) protocols and infrastructures. In one embodiment, the screen component utilizes a wireless communication protocol or RF standard, such as Bluetooth or an Ultra Low Power (ULP) Bluetooth protocol, or other wireless protocol to enable communication between the smart device and the screen component. Further, the device then wirelessly syncs with linked (paired) smart devices. Once synced, the user can control the screen component of the device via a mobile application on the paired smart device. Furthermore, photos and/or videos from the linked smart device can be streamed to the screen component for display via the mobile application.

In one embodiment, the screen component incorporates a minimum amount of communications circuitry which may be imbedded or integrated into the screen component. For example, the screen component can minimally include a processor, transceiver, memory, a power source such as a long-life battery, and an antenna which is integrated into the screen component. With additional innovations in battery technology, batteries such as lithium-ion batteries can be provided which allows for the screen component to operate for relatively long time periods. In another embodiment, the screen component comprises an electrical plug that can be plugged into a conventional wall socket for powering the device.

In one embodiment, the screen component comprises an antenna coupled to an RF transceiver device. The transceiver, processor, and internal memory each receive power from a power source, such as a battery. Components such as an antenna, a transceiver, a processor, and a memory can vary according to those known in the art and used in smart devices such as cellular and mobile phones. An exemplary screen component may receive an activation signal via the antenna and through the transceiver which is registered by the processor. As a next step, the processor may interrogate the memory for specific identification information assigned in the memory. For example, the screen component identifies each smart device that is paired to it for syncing photos and/or videos to the screen component.

In one embodiment, the internal memory of the screen component stores data from the smart device so that photos and videos can be displayed on the screens or screen sections even when the smart device is not currently linked to the smart device.

In one embodiment, the screen component also comprises a power control button for powering on and off the device.

In one embodiment, the power source is a battery, typically a rechargeable battery that can be recharged via a USB port. In this embodiment, the USB port is positioned on the screen component in any suitable position as is known in the art.

In one embodiment, the screen component pairs with a mobile application on a smart device. The mobile application includes an easy-to-use interface which allows users to sync images and videos directly from their device through the related mobile application. The mobile application allows users to customize the screen layout, assign specific images or videos to different screens, and set photos to rotate automatically. Specifically, the mobile application allows for easy drag and drop photo and video arrangement via the interface.

In one embodiment, the screen component allows for optional customizable screen titles on the photos and/or videos. Specifically, users can utilize the interface of the mobile application to add customizable screen titles on the photos and/or videos with ease.

In one embodiment, users can add expansion kits to the device, to increase the size and/or number of photos/videos which can be added to the screen component.

In yet another embodiment, the digital photo collage frame device comprises a plurality of indicia.

In yet another embodiment, a method of displaying multiple images and videos across a digital screen is disclosed. The method includes the steps of providing a digital photo collage frame device comprising a screen component that interacts with a mobile application on a smart device. The method also comprises logging into a mobile application on a paired smart device. Further, the method comprises syncing images and videos directly from a smart device to the screen component. The method also comprises customizing the layout of the screen component with images and videos from the smart device. Finally, the method comprises displaying the images and videos on the screen component in an interactive way.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the digital photo collage frame device of the present invention in accordance with the disclosed architecture;

FIG. 2 illustrates a perspective view of one embodiment of the digital photo collage frame device of the present invention showing the device interacting with a smart device in accordance with the disclosed architecture;

FIG. 3 illustrates a perspective view of one embodiment of the digital photo collage frame device of the present invention showing the mobile application on the smart device in accordance with the disclosed architecture;

FIG. 4 illustrates a perspective view of one embodiment of the digital photo collage frame device of the present invention showing multiple screens in accordance with the disclosed architecture;

FIG. 5 illustrates a perspective view of one embodiment of the digital photo collage frame device of the present invention showing the device secured to a wall in accordance with the disclosed architecture;

FIG. 6 illustrates a perspective view of one embodiment of the digital photo collage frame device of the present invention showing the device in use in accordance with the disclosed architecture;

FIG. 7 illustrates a perspective view of one embodiment of the digital photo collage frame device of the present invention showing the screen component interacting with the smart device in accordance with the disclosed architecture;

FIGS. 8A-B illustrate a perspective view of one embodiment of the digital photo collage frame device of the present invention showing the components and easy-to-use mobile application in accordance with the disclosed architecture; and

FIG. 9 illustrates a flowchart showing the method of displaying multiple images and videos across a digital screen in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a digital photo collage frame device that allows a user to create a wall-mounted digital scrapbook picture collage. There is also a long felt need in the art for a digital photo collage frame device that makes it easy to show multiple digital photos at once in a compact and stylish wall-mounted display. Further, there is a long felt need in the art for a digital photo collage frame device that can wirelessly sync with a linked mobile application so it's easy to choose the photos and videos to display, place them in specific positions, and rotate pictures to create the perfect display. Moreover, there is a long felt need in the art for a device that stores data so photos can display even without the linked smart phone. Further, there is a long felt need in the art for a digital photo collage frame device that can include optional customizable screen titles. Finally, there is a long felt need in the art for a digital photo collage frame device that allows each frame to display a still photo or multiple pictures in rotation.

The present invention, in one exemplary embodiment, is a novel digital photo collage frame device. The digital photo collage frame device comprises a screen component designed to display multiple images and that interacts with a mobile application on a smart device. The screen component is Bluetooth-enabled and compatible with any smart device which allows users to sync images and videos directly from their device through the related, easy-to-use mobile application. The mobile application allows users to customize the collage layout, assign specific images or videos to different screens, and set photos to rotate automatically. The device is designed as a single screen which is broken up into sections or as multiple screens which snap together or apart so a user may arrange, add, remove, etc., based upon their preference. The present invention also includes a novel method of displaying multiple images and videos across a digital screen. The method includes the steps of providing a digital photo collage frame device comprising a screen component that interacts with a mobile application on a smart device. The method also comprises logging into a mobile application on a paired smart device. Further, the method comprises syncing images and videos directly from a smart device to the screen component. The method also comprises customizing the layout of the screen component with images and videos from the smart device. Finally, the method comprises displaying the images and videos on the screen component in an interactive way.

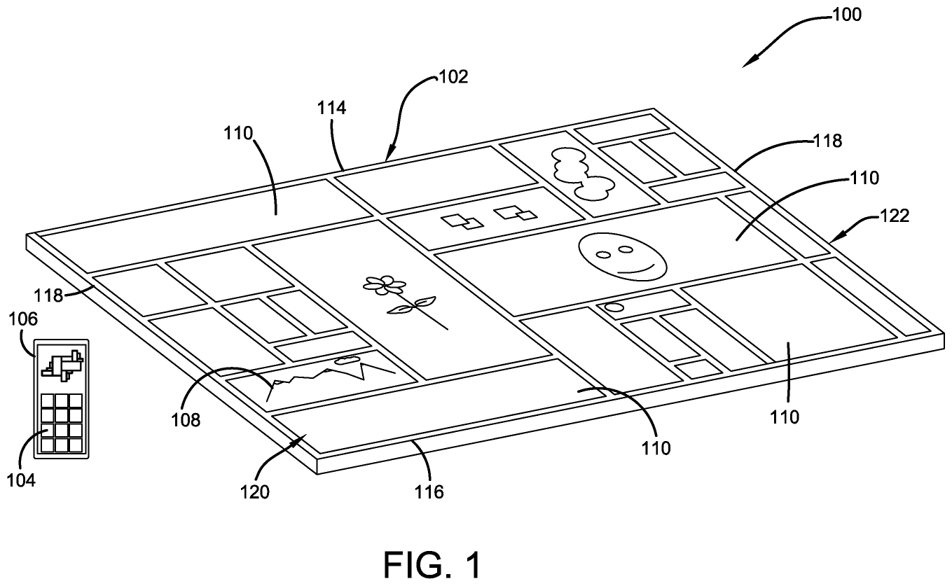

Referring initially to the drawings, FIG. 1 illustrates a perspective view of one embodiment of the digital photo collage frame device 100 of the present invention. In the present embodiment, the digital photo collage frame device 100 is an improved digital photo collage frame device 100 that provides a user with a frame for displaying multiple digital images and videos in a wall-mounted collage. Specifically, the digital photo collage frame device 100 comprises a screen component 102 designed to display multiple images and that interacts with a mobile application 104 on a smart device 106. The screen component 102 is Bluetooth-enabled and compatible with any smart device 106 which allows users to sync images 108 and videos directly from their device 100 through the related, easy-to-use mobile application 104. The device 100 offers users a convenient and interactive way to display memories, creating a personalized experience for users.

Generally, the digital photo collage frame device 100 displays multiple photos 108 without the need to link multiple frames. The device 100 is a wireless digital photo frame that allows users to display multiple photos 108 and videos in a customized arrangement and which can be set to rotate automatically through a plurality of previously selected photos 108 and videos. The digital photo collage frame device 100 wirelessly syncs with linked smart devices 106 via Bluetooth and interacts with an easy-to-use mobile application 104 on the smart devices 106.

Further, the digital photo collage frame device 100 comprises a screen component 102 for displaying digital photos 108 and videos. The screen component 102 can be any suitable shape and size as is known in the art for displaying multiple photos 108 and videos. In one embodiment, the screen component 102 is a single screen in a rectangular shape which is broken up into multiple sections 110. The multiple sections 110 are different framed areas of the singular screen. The screen component 102 disclosing a single screen can be of varying sizes depending on the needs and/or wants of a user. In another embodiment, the screen component 102 comprises multiple separate screens 112 which snap together or apart so a user may arrange, add, remove, etc., based upon their preference, thus allowing users to interconnect the multiple screens 112 in a customizable arrangement. The multiple screens 112 can be of varying sizes depending on the needs and/or wants of a user.

Additionally, the screen component 102 can be any suitable shape and size as is known in the art, as long as the screen component 102 is sized and shaped to retain all the needed components and circuitry for displaying a photo 108 or video from the smart device 104. In the present embodiment, the screen component 102 comprises a top end 114, a bottom end 116, opposing side ends 118, a front surface 120, and a rear surface 122.

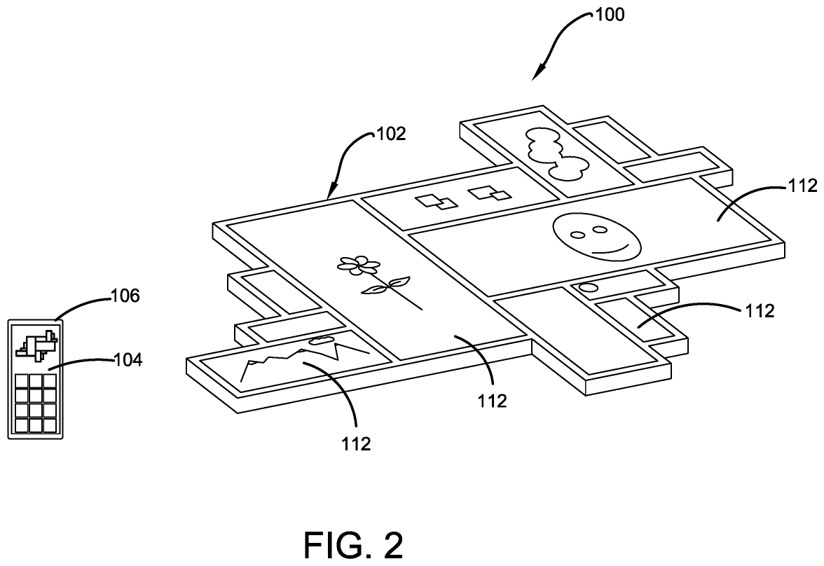

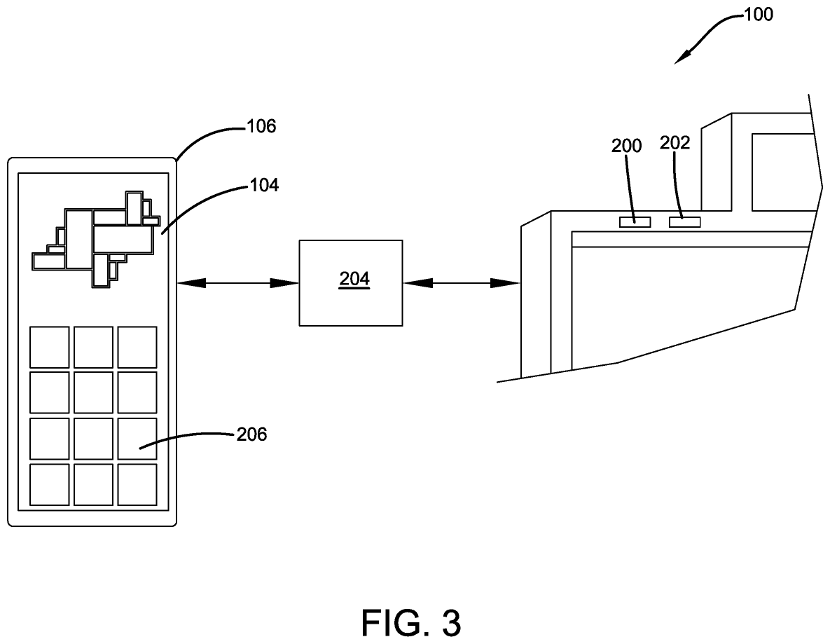

As shown in FIGS. 2-3, the screen component 102 comprises components, such as a microprocessor 200 and transceiver 202 which is compliant and compatible with existing smart device (cellular and mobile telephone phone) protocols and infrastructures. In one embodiment, the screen component 102 utilizes a wireless communication protocol 204 or RF standard, such as Bluetooth or an Ultra Low Power (ULP) Bluetooth protocol, or other wireless protocol to enable communication between the smart device 104 and the screen component 102. Further, the device 100 then wirelessly syncs with linked (paired) smart devices 106. Once synced, the user can control the screen component 102 of the device 100 via a mobile application 104 on the paired smart device 106. Furthermore, photos 108 and/or videos from the linked smart device 106 can be streamed to the screen component 102 for display via the mobile application 104.

Further, the screen component 102 pairs with a mobile application 104 on a smart device 106. The mobile application 104 includes an easy-to-use interface 206 which allows users to sync images 108 and videos directly from their device 100 through the related mobile application 104. The mobile application 104 allows users to customize the screen layout, assign specific images 108 or videos to different screens, and set photos 108 to rotate automatically. Specifically, the mobile application 104 allows for easy drag and drop photo 108 and video arrangement via the interface 206.

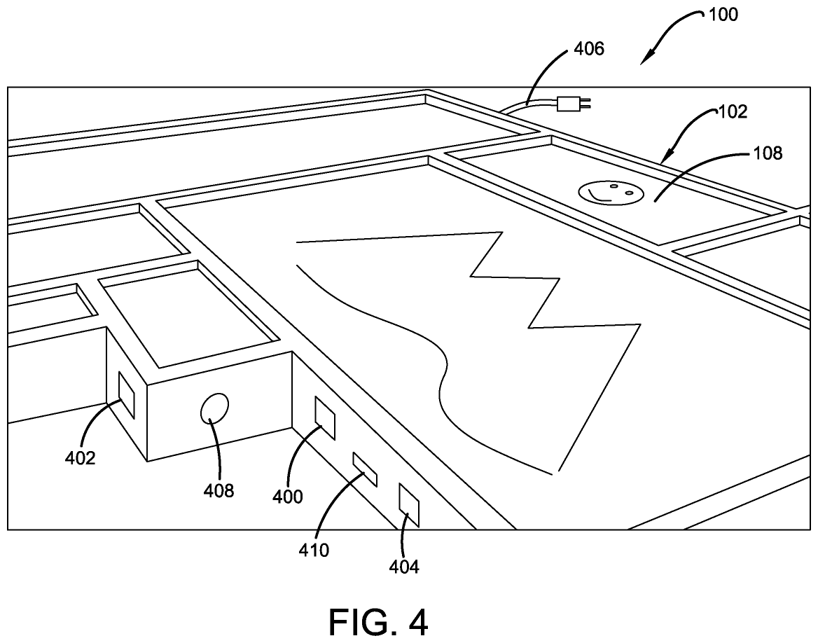

As shown in FIG. 4, the screen component 102 incorporates a minimum amount of communications circuitry which may be imbedded or integrated into the screen component 102. For example, the screen component 102 can minimally include a processor 200, transceiver 202, memory 400, a power source such as a long-life battery 402, and an antenna 404 which is integrated into the screen component 102. With additional innovations in battery technology, batteries 402 such as lithium-ion batteries can be provided which allows for the screen component 102 to operate for relatively long time periods. In another embodiment, the screen component 102 comprises an electrical plug 406 that can be plugged into a conventional wall socket for powering the device 100.

Further, the screen component 102 comprises an antenna 404 coupled to an RF transceiver device 202. The transceiver 202, processor 200, and internal memory 400 each receive power from a power source, such as a battery 402. Components such as an antenna 404, a transceiver 202, a processor 200, and a memory 400 can vary according to those known in the art and used in smart devices 106 such as cellular and mobile phones. An exemplary screen component 102 may receive an activation signal via the antenna 404 and through the transceiver 202 which is registered by the processor 200. As a next step, the processor 200 may interrogate the memory 400 for specific identification information assigned in the memory 400. For example, the screen component 102 identifies each smart device 106 that is paired to it for syncing photos 108 and/or videos to the screen component 102.

Additionally, the internal memory 400 of the screen component 102 stores data from the smart device 106 so that photos 108 and videos can be displayed on the screens 112 or screen sections 110 even when the screen component 102 is not currently linked to the smart device 106.

Furthermore, the screen component 102 also comprises a power control button 408 for powering on and off the device 100. Further, the screen component 102 can include any other control buttons as deemed necessary for operating the device 100.

In one embodiment, the battery 402 may be a disposable battery or a rechargeable battery in the form of an alkaline, nickel-cadmium, nickel-metal hydride battery, etc., such as any 3V-12 volts DC battery or other conventional battery, such as A, AA, AAA, that supplies power to the digital photo collage frame device 100. Throughout this specification, the term “battery” may be used interchangeably to refer to one or more wet or dry cells or batteries of cells in which chemical energy is converted into electricity and used as a source of DC power. References to recharging or replacing the battery 402 may refer to recharging or replacing individual cells, individual batteries of cells, or a package of multiple battery cells as is appropriate for any given battery technology that may be used. In addition, a rechargeable embodiment of the battery 402 may be recharged using a USB port 410, wherein the USB port 410 is a USB-A, USB-B, Micro-B, Micro-USB, Mini-USB, or USB-C port, etc.

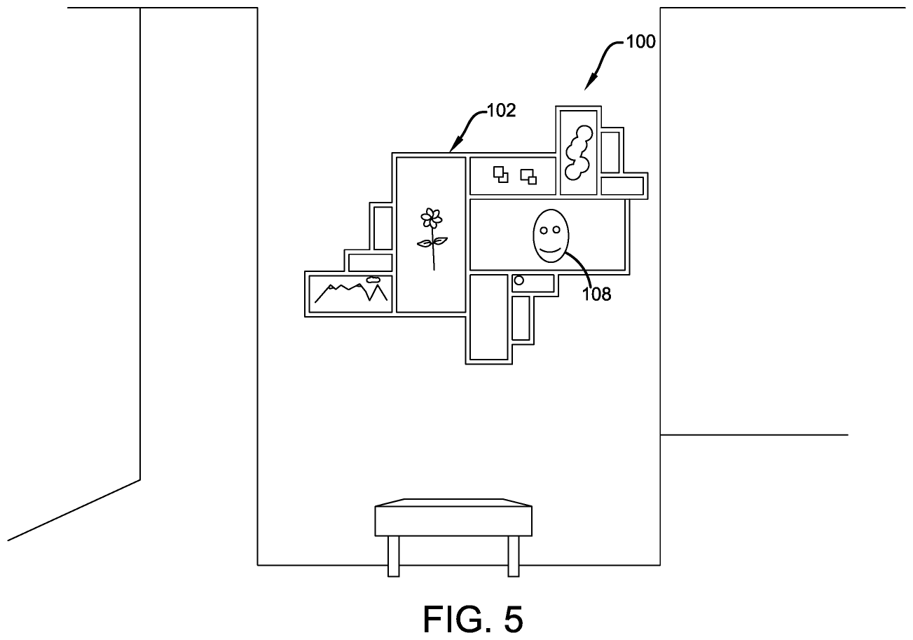

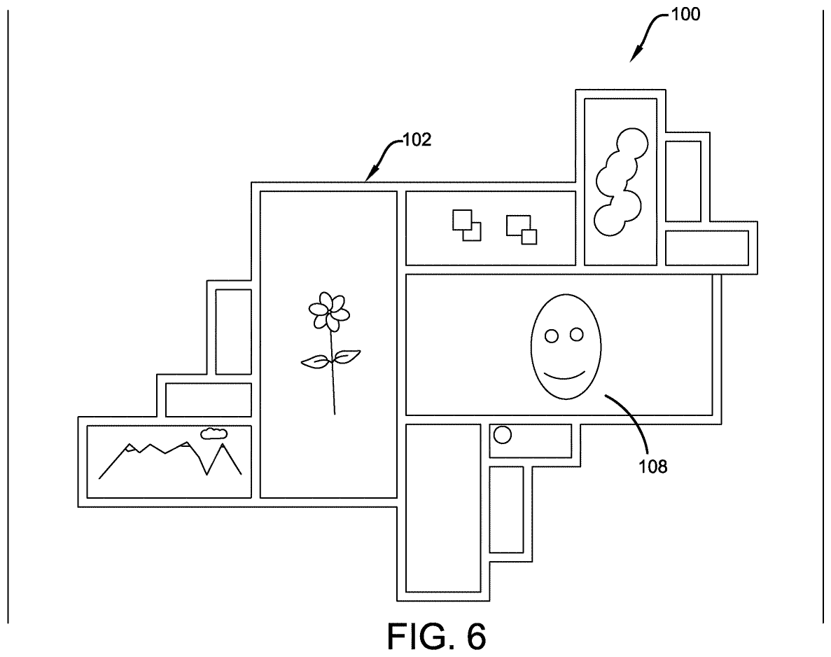

As shown in FIGS. 5-6, the single screen 102 with multiple sections 110 and the multiple screens 112 connected together can be manufactured in multiple sizes with various size screens, such as small, medium, and large, and may vary in portrait and landscape style, as well. Typically, the screen component 102 is sized to the most common smart device ratio (19:9). For example, two large screens, four medium screens, six small screens, or other suitable ratio of screen sizes. Typically, the small, medium, and large screens are equally divided between landscape and portrait orientations. In one embodiment, the overall measurements of the screen component 102 include approximately 40 inches wide by approximately 30 inches high but can be any suitable size as is known in the art.

Further, each screen 112 or section 110 of a single screen 102 can display a still photo 108 or multiple pictures in rotation or displays up to one minute of video loop playback. A user can assign specific images 108 or videos to different screens 112 or different sections 110 of a single screen 102, and set photos 108 to rotate automatically, thus allowing users to customize the collage device 100 layout. Thus, the device 100 offers users a convenient and interactive way to display memories, creating a personalized experience for users.

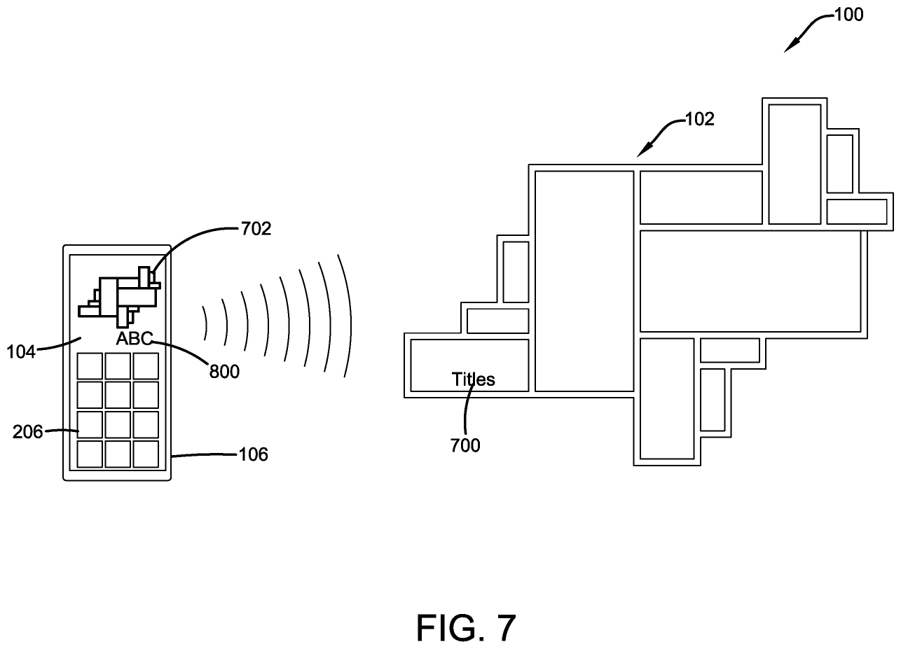

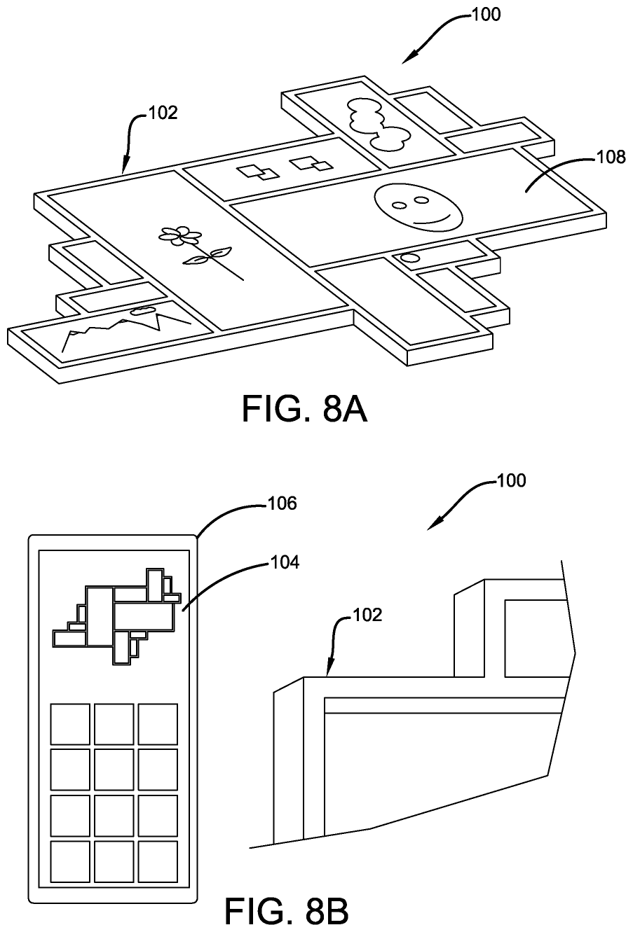

As shown in FIGS. 7 and 8A-B, the screen component 102 allows for optional customizable screen titles 700 on the photos 108 and/or videos. Specifically, users can utilize the interface 206 of the mobile application 104 to add customizable screen titles 700 on the photos 108 and/or videos with ease.

Further, users can add expansion kits 702 to the device 100, to increase the size and/or number of photos/videos which can be added to the screen component 102.

In yet another embodiment, the digital photo collage frame device 100 comprises a plurality of indicia 800. The screen component 102 of the device 100 may include advertising, a trademark, or other letters, designs, or characters, printed, painted, stamped, or integrated into the screen component 102, or any other indicia 800 as is known in the art. Specifically, any suitable indicia 800 as is known in the art can be included, such as but not limited to, patterns, logos, emblems, images, symbols, designs, letters, words, characters, animals, advertisements, brands, etc., that may or may not be photos, collage frame, or brand related.

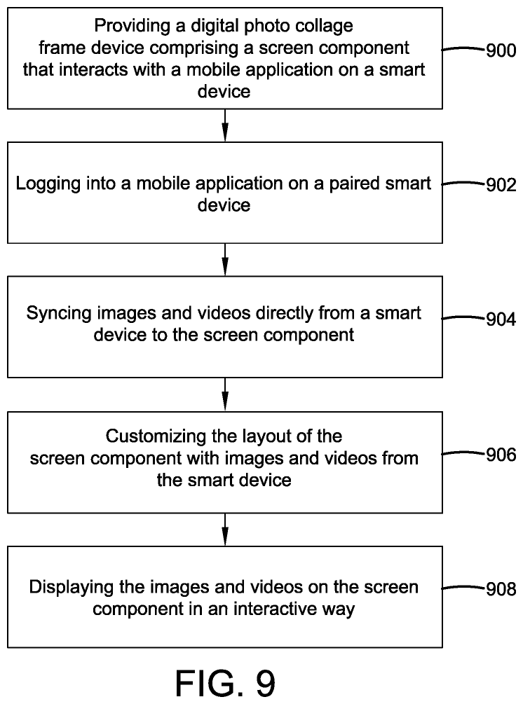

FIG. 9 illustrates a flowchart of the method of displaying multiple images and videos across a digital screen. The method includes the steps of at 900, providing a digital photo collage frame device comprising a screen component that interacts with a mobile application on a smart device. The method also comprises at 902, logging into a mobile application on a paired smart device. Further, the method comprises at 904, syncing images and videos directly from a smart device to the screen component. The method also comprises at 906, customizing the layout of the screen component with images and videos from the smart device. Finally, the method comprises at 908, displaying the images and videos on the screen component in an interactive way.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “digital photo collage frame device”, “digital photo device”, “collage frame device”, and “device” are interchangeable and refer to the digital photo collage frame device 100 of the present invention.

Notwithstanding the foregoing, the digital photo collage frame device 100 of the present invention can be of any suitable size and configuration as is known in the art without affecting the overall concept of the invention, provided that it accomplishes the above stated objectives. One of ordinary skill in the art will appreciate that the digital photo collage frame device 100 as shown in FIGS. 1-9 is for illustrative purposes only, and that many other sizes and shapes of the digital photo collage frame device 100 are well within the scope of the present disclosure. Although the dimensions of the digital photo collage frame device 100 are important design parameters for user convenience, the digital photo collage frame device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A digital photo collage frame device that provides a user with a frame for displaying multiple digital images in a wall-mounted collage, the digital photo collage frame device comprising:
a screen component;
wherein the screen component is Bluetooth-enabled and compatible with a smart device; and
further wherein users can sync photos and videos directly from the smart device through a mobile application on the smart device.

2. The digital photo collage frame device of claim 1, wherein the screen component is a single screen in a rectangular shape which is broken up into multiple sections, which are different framed areas of the singular screen.

3. The digital photo collage frame device of claim 1, wherein the screen component comprises multiple separate screens which snap together or apart so a user may arrange, add, or remove, based upon their preference.

4. The digital photo collage frame device of claim 1, wherein the screen component comprises a top end, a bottom end, opposing side ends, a front surface, and a rear surface.

5. The digital photo collage frame device of claim 4, wherein the screen component comprises components, such as a microprocessor, a transceiver, and a memory.

6. The digital photo collage frame device of claim 5, wherein the screen component utilizes a wireless communication protocol or RF standard, such as Bluetooth or an Ultra Low Power (ULP) Bluetooth protocol, or other wireless protocol to enable communication between the smart device and the screen component.

7. The digital photo collage frame device of claim 6, wherein the digital photo collage frame device then wirelessly syncs with a paired smart device to control the screen component via a mobile application on the paired smart device, and photos or videos from the paired smart device can be streamed to the screen component for display via the mobile application.

8. The digital photo collage frame device of claim 7, wherein the mobile application includes an easy-to-use interface which allows for easy drag and drop photo and video arrangement and allows users to customize screen layout, assign specific photos or videos to different screens, and set photos to rotate automatically.

9. The digital photo collage frame device of claim 8, wherein the screen component includes a battery and an antenna.

10. The digital photo collage frame device of claim 9, wherein the memory of the screen component stores data from the smart device so that photos and videos can be displayed on the screen component even when not currently linked to the smart device.

11. The digital photo collage frame device of claim 10, wherein the screen component comprises a power control button for powering on and off the digital photo collage frame device.

12. A digital photo collage frame device that provides a user with a frame for displaying multiple digital images in a wall-mounted collage, the digital photo collage frame device comprising:
a screen component comprising a microprocessor, a transceiver, a memory, a battery, and an antenna;
wherein the screen component is a single screen in a rectangular shape which is broken up into multiple sections; or the screen component comprises multiple separate screens which snap together or apart so a user may arrange, add, or remove, based upon their preference;
wherein the screen component utilizes a wireless communication protocol or RF standard, such as Bluetooth or an Ultra Low Power (ULP) Bluetooth protocol, or other wireless protocol to enable communication between the smart device and the screen component;
wherein the digital photo collage frame device then wirelessly syncs with a paired smart device to control the screen component via a mobile application on the paired smart device, and photos or videos from the paired smart device can be streamed to the screen component for display via the mobile application;
wherein the mobile application includes an easy-to-use interface which allows for easy drag and drop photo and video arrangement and allows users to customize screen layout, assign specific photos or videos to different screens, and set photos to rotate automatically; and
further wherein the memory of the screen component stores data from the smart device so that photos and videos can be displayed on the screen component even when not currently linked to the smart device.

13. The digital photo collage frame device of claim 12, wherein the screen component can be manufactured in multiple sizes with various size screens, such as small, medium, and large, and may vary in portrait and landscape style, as well.

14. The digital photo collage frame device of claim 13, wherein the screen component is sized to a smart device ratio (19:9), such as two large screens, four medium screens, and six small screens.

15. The digital photo collage frame device of claim 14, wherein the screen component is approximately 40 inches wide by approximately 30 inches high.

16. The digital photo collage frame device of claim 15, wherein each screen or section of the screen component can display a still photo or multiple pictures in rotation or displays up to one minute of video loop playback.

17. The digital photo collage frame device of claim 16, wherein the screen component allows for optional customizable screen titles on the photos or videos.

18. The digital photo collage frame device of claim 16, wherein users can add expansion kits to the screen component.

19. The digital photo collage frame device of claim 16 further comprising a plurality of indicia.

20. A method of displaying multiple images and videos across a digital screen, the method comprising the following steps:
providing a digital photo collage frame device comprising a screen component that interacts with a mobile application on a smart device;
logging into a mobile application on a paired smart device;
syncing images and videos directly from a smart device to the screen component;
customizing the layout of the screen component with images and videos from the smart device; and
displaying the images and videos on the screen component in an interactive way.
